(19) United States
(12) Patent Application Publication
(10) Pub. No.: US 2013/0145663 A1
(43) Pub. Date: Jun. 13, 2013

(54) Laser Printer Processible Non-Woven Fabric Wristband

(71) Applicant: Mark Greer, O'Fallon, MO (US)

(72) Inventor: Mark Greer, O'Fallon, MO (US)

(73) Assignee: LASER BAND, LLC, St. Louis, MO (US)

(21) Appl. No.: 13/314,911

(22) Filed: Dec. 8, 2011

(51) Int. Cl. A44C 5/00; G09F 3/02; G09F 3/10

(52) U.S. Cl. 40/633

(57) ABSTRACT

A wristband business form comprising a non-woven fabric wristband as part of a laser printer processible form. The form has several embodiments including a wristband die cut into a web of non-woven fabric, with the fabric web adhered to a carrier web, or a pre-cut fabric wristband releasably adhered to a carrier web. The fabric wristband may be releasably adhered in any one of several ways including with a plurality of dots of adhesive, a dry release adhesive or a layer of a light tack adhesive. A layer of solvent or acrylic resin or the like may be applied to the fabric wristband to enhance the ability of a laser printer to apply an image, although that is considered as an optional feature.

### CROSS-REFERENCE TO RELATED APPLICATIONS

None.

### STATEMENT REGARGING FEDERALLY SPONSORED RESEARCH OR DEVELOPMENT

Not Applicable.

### APPENDIX

Not Applicable.

### BACKGROUND OF THE INVENTION

Non-woven fabric wristbands are probably the most common wristband construction on the market. Made of popular materials like DuPont's Tyvek, these bands are best known as Tyvek® wristbands and are used for theme parks, concerts, entertainment, healthcare, resorts, sporting events, etc. These bands are a favorite because they are so versatile and inexpensive. Many wristband manufacturers offer a number of stock preprinted bands with themed graphics and sequential numbering, and custom printed band orders can be routinely printed and delivered in less than a week. Examples of these wristbands are presently manufactured by Precision Dynamics Corp., MedTech Wristbands, Trendy Wristbands, Price Chopper Wristbands, National Ticket, Wristco, and Rippedsheet Wristbands. As such, they are also readily adaptable to be “affinity” bands and serve an advertising function as well. These bands, being made of flexible fabric, are easy to apply and despite being relatively soft and comfortable to the wearer, hold up well under short term use in abusive conditions such as at sporting events, theme parks and swimming pools. These bands typically range from ½″ to 1″ wide by 10″ long; sized to comfortably wrap around the typical adult wrist and overlap to adhere its ends. However, despite being pre-printed with a common logo or advertising identity, a common purchaser complaint and limitation of these non-woven fabric wristbands is there is no convenient way to apply variable data, aka “print on demand”, as the bands are typically supplied in a fan fold configuration, joined along their long sides, and adapted to be readily torn off for individual use. This makes them virtually impossible to be processed through the typical printer, today that would be a laser printer, which would ordinarily be used to do a “print-on-demand” process by a purchaser after having received a supply of bands. This drawback limits their applicability as for many uses a purchaser needs to be able to imprint the bands with variable information on their premises typically with a laser printer, such as a unique bar code, Doctor's name, specific health information such as allergies, a wearer's identity, etc. An example of an application for this invention is out patient banding at hospitals or clinics, where a simple band could be quickly prepared on a laser printer at a much lower cost than the longer term higher priced bands that are currently used for multi day hospital stays. As these are high volume applications, a savings of even a few pennies a band can represent significant savings over time.

A typical lower cost wristband form widely available today incorporates a synthetic film material such as polypropylene or the like, and while it may be printed with low temperature printers such as ink jet printers, it cannot be processed with high temperature printers such as laser printers which are widely in use today. The higher temperature printing process used in laser printers damages the synthetic film and makes this type of wristband form impossible to use in most modern printing applications. Thus, while these low cost wristband forms are available for use with old style ink jet printers, they are not being used for new applications.

The present invention solves this long felt need for a purchaser to be able to easily generate variable data Tyvek wristbands with almost any laser printer. Essentially, as illustrated in one of the preferred embodiments, the invention preferably comprises a web of non-woven fabric, such as Tyvek®, pattern adhered to the top of a carrier web of any suitable material such as plain paper, the two webs being substantially co-extensive, and a die cut forming the wristband in the non-woven fabric web only yet secured enough to withstand processing through a laser printer or the like without separating, but readily separable thereafter by a user. In a preferred embodiment, the die cut forming the band may have a series of interruptions so that a plurality of “ties” are formed intermittently along the outer perimeter of the band which hold it together with the rest of the non-woven fabric web. A user may then conveniently separate the band by inserting a finger between two ties and lifting the band to burst the ties, thereby separating the band. Other arrangements may be used as well for securing the band, such as with a patterned adhesive in combination with the ties or in place of the ties.

Another preferred embodiment further minimizes the use of the relatively more expensive non-woven fabric by adhering a pre-cut non-woven fabric wristband to a carrier made from less expensive materials such as plain bond paper. Different techniques are preferably used to adhere the non-woven fabric wristband such as with a plurality of dots of adhesive placed around the periphery of the wristband, or by adhering the wristband with a “dry release” adhesive, or by using a light tack adhesive similar to that used with the ubiquitous Post-it® notes in common use in virtually every office.

Yet another inventive feature of the invention, as described in the preferred embodiments, is that the web of non-woven fabric may be over-printed with a substance to fill in the irregular surface of the non-woven material, to thereby enhance the capability of a laser printer to create an image thereon. This improves the appearance of the printed material and especially its readability including not only for text but also bar codes and other machine readable information. While this technique has been used before to enhance other kinds of image application, to the inventor's knowledge it has not been done to enhance a laser printer image including text and bar code information as applied to a non-woven fabric wristband. Suitable materials are known in the art, but have not been adapted to this application as best known by the inventor.

The non-woven fabric wristband may be provided in a wristband form suitable for laser printing in a number of different arrangements such as by itself in a sheetlet, in combination with a matrix of self-adhering labels, in a page format with multiple wristbands only, the same multi-wristband format some of which may be of different lengths such as in a Mother-Father-Baby format as known in the art, etc.

While the principal advantages and features of the present invention have been briefly mentioned above, a fuller understanding of the invention may be gained by referring to the drawings and the detailed description of the preferred embodiments which follow.

### BRIEF DESCRIPTION OF THE DRAWINGS

FIG. 1 depicts a plan view of a page sized wristband/label form with a partial upper web of non-woven fabric having a die cut defining a wristband therein and a partial upper web die cut to form a matrix of self-adhering labels, both of which are adhered to a bottom web carrier;

FIG. 2 depicts a plan view of the form shown in FIG. 1 and which details a layer of patterned adhesive for joining the non-woven fabric web to the carrier web;

FIG. 3 depicts a plan view of a page sized form with a plurality of non-woven fabric wristbands die cut into a full page sized web, the wristbands being of the same length;

FIG. 4 depicts a plan view of a sheetlet form with a single non-woven fabric wristband die cut into a non-woven fabric web;

FIG. 5 depicts a plan view of a sheetlet form with a single non-woven fabric wristband die cut into a non-woven fabric web and a second paper filler web adjacent the fabric web;

FIG. 6 depicts a top view of a combo form having a pre-cut non-woven fabric wristband adhered to a paper carrier with a matrix of self-adhering labels;

FIG. 7 depicts a top view of the paper carrier of the combo form of FIG. 6 with a plurality of adhesive dots around the periphery of the wristband silhouette for adhering the wristband to the carrier;

FIG. 8 depicts a top view of the paper carrier of a combo form detailing the application of a layer of light tack or dry release adhesive and a patch of adhesive for the end tab;

FIG. 9 depicts a sheetlet with a pre-cut non-woven wristband adhered to a paper carrier.

### DETAILED DESCRIPTION OF THE PREFERRED EMBODIMENT

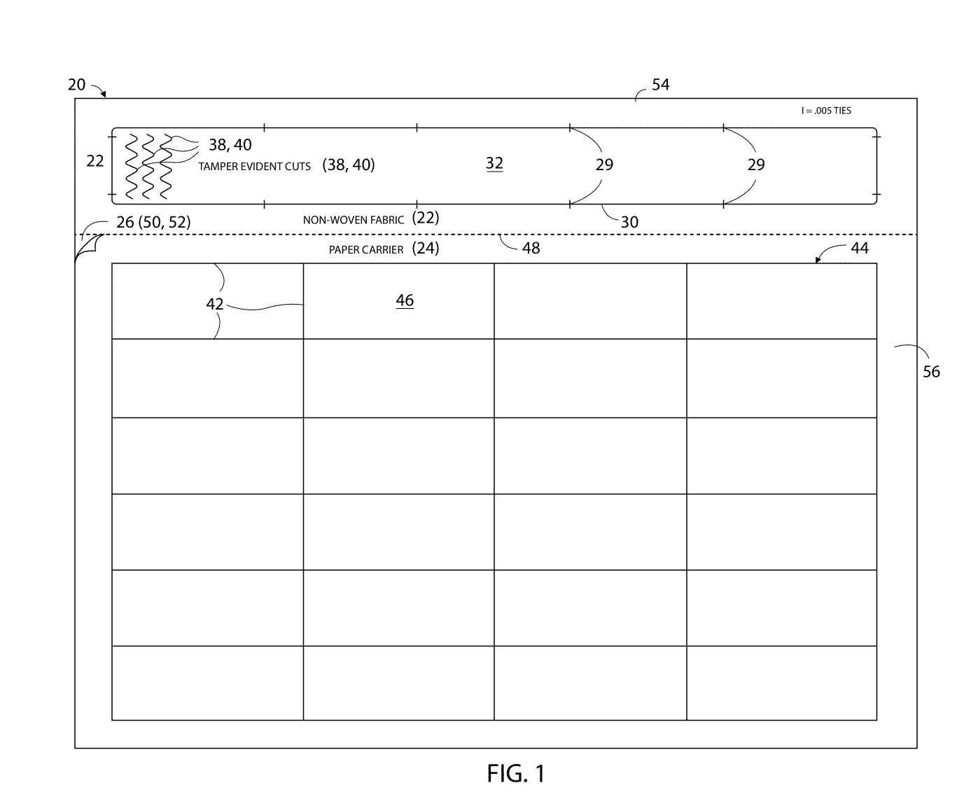

As shown in the various figures, the present invention may take several different arrangements to fit the particular user need and application. As shown in FIG. 1, the wristband form 20 preferably comprises a page sized sheet with an upper, partial web 22 made of a non-woven fabric such as Tyvek® or the like and a second upper, partial web 24 made of a suitable paper such as ordinary bond or the like. Other materials suitable for use instead of Tyvek® are known in the industry as spunbond or spunlaid. Spunlaid non-wovens are made in one continuous process by polymer fibers being blown onto a conveyor belt and then thermally bound to produce a continuous web of non-woven fabric. Two such fibers that are considered by the inventor to be suitable are polyethylene and polyester. Typical manufacturers of these non-woven fabrics include: Cerex Advanced Fabrics, Inc., Du Pont, Northeastern Nonwovens, Inc., Foshan S.L.P. Special Materials Co, LTD, Foss Manufacturing Co, Vita Nonwovens, First Quality Nonwovens, BMP World Wide, Xiamen Elite, and Concord Nonwovens.

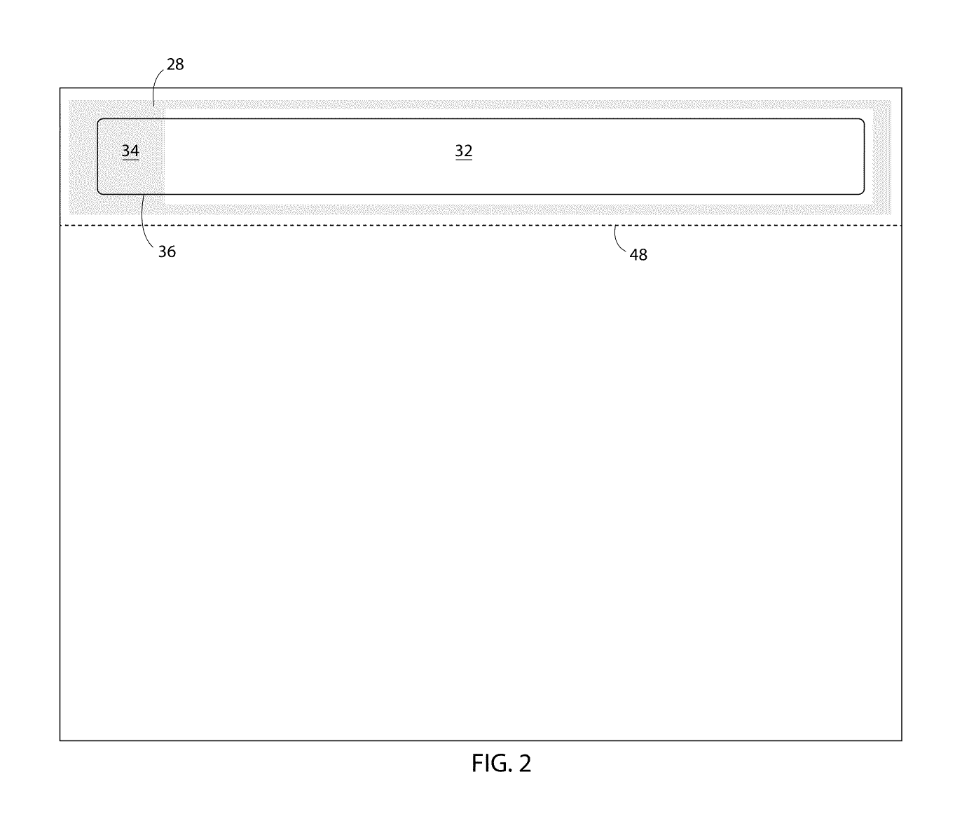

Both of these partial, upper webs 22, 24 are arranged adjacent to each other and substantially cover and are adhered to a carrier web 26 which may be made of a thinner, less expensive paper or synthetic which may be coated with a patterned adhesive layer 28 as shown in FIG. 2. The non-woven fabric web 22 is preferably bonded to the carrier web 26 by means of a layer of a pattern pressure sensitive adhesive (PSA), so that only the outer edges of the non-woven web 22 are secured to the carrier web 26. This allows the midsection of the non-woven web to be die cut into a common sized wristband, such as preferably 1″×10″ for example, and held in place via ties 29 along the edges of the band until the user images the sheet and removes the printed wristband. As known in the art, the ties 29 may be conveniently formed by gaps in the die used to die cut the wristband. Additionally a patch of silicone release coating is preferably applied to the carrier ply and a PSA applied on to the silicone positioned under the tab end of the wristband, so that upon removing the band from the carrier, one end of the band, known as the tab end would have a patch of adhesive for securing the band around ones wrist.

The fabric web 22 has a die cut 30 forming a strap or wristband 32 of generally rectangular shape with a series of ties 29 interrupting the die cut 30 for holding the wristband 32 in place as the form is processed through a laser printer, ink jet printer, or other such printer as known in the art. As shown in FIG. 2, a portion 34 of the pattern adhesive layer 28 underlies one end 36 of the wristband 32 and separates with the wristband 32 as it is separated from the form 20. This adhesive portion 34 thus provides a means for securing the wristband 32 about a wearer's wrist after being wrapped therearound. A series of second die cuts 38 forms a tamper evident feature 40 so that, once applied to a wrist, they separate upon removal of the wristband to prevent the band 32 from being reused without being noticed. Yet another plurality of die cuts 42 form a matrix 44 of self-adhering labels 46 which may be individually separated after being printed with the identifying information as printed on the wristband 32, as desired for use in many applications such with patients in the health care field. A line of perforation 48 separates the carrier web 26 into two portions 50, 52 so that the wristband portion 54 of the form 20 may be separated from the label portion 56 for use independently of each other.

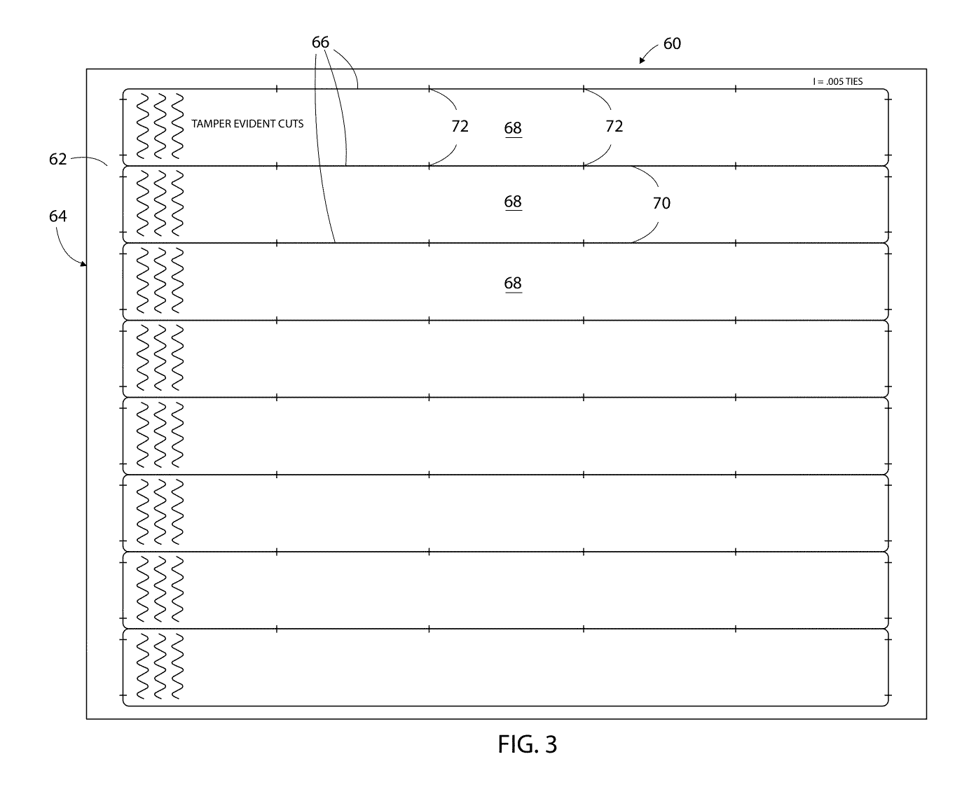

As shown in FIG. 3, a second page sized wristband form 60 includes a full page sized upper web 62 made of a non-woven fabric such as Tyvec® adhered with a layer of patterned adhesive similar to that as shown in FIG. 2 to a full page sized carrier web 64 made of less expensive paper or synthetic material. A series of die cuts 66 form a plurality of straps or wristbands 68 aligned to be substantially adjacent to each other along their longest edges 70. As in the embodiment of FIG. 1, a series of ties 72 keep the bands 68 affixed in place as the form is processed through a printer and may then be burst to permit separation and use of any one or more bands 68.

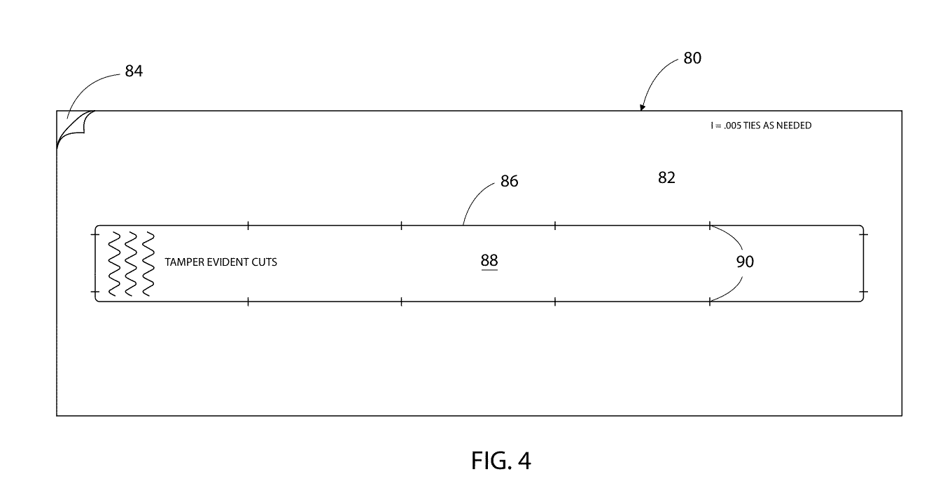

As shown in FIG. 4, a sheetlet 80 form includes an upper non-woven fabric web 82 adhered to a carrier web 84 by a layer of patterned adhesive similar to that shown in FIG. 2, with a die cut 86 forming a strap or wristband 88 with a series of ties 90. This form 80 is noteworthy for its overall dimensions which are substantially the same as an envelope.

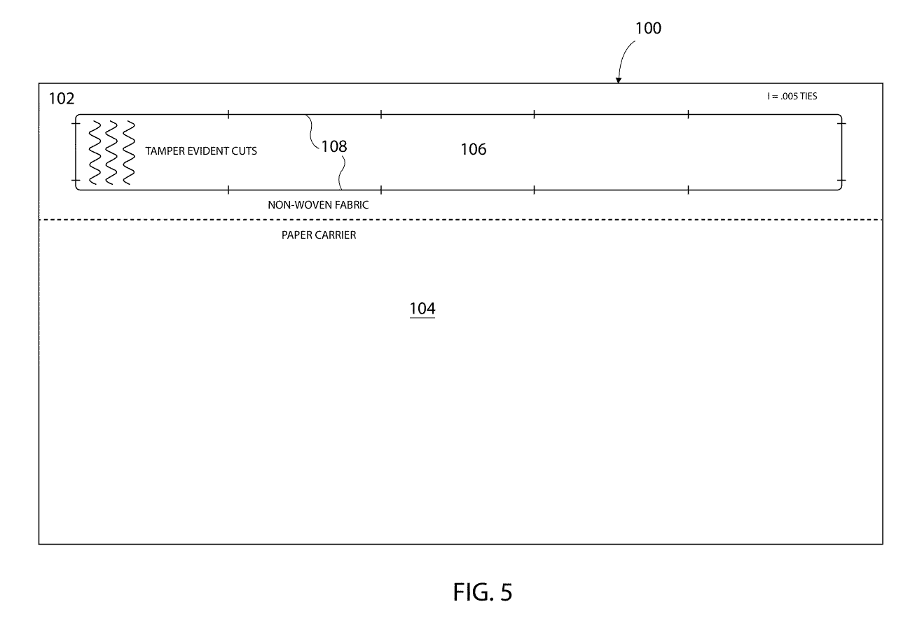

As shown in FIG. 5, another sheetlet 100 form includes a partial upper non-woven fabric web 102 which is pattern adhered to a paper or synthetic carrier web 104 similar to the other embodiments. A wristband 106 is die cut into the fabric web 102 by an interrupted die cut 108, similarly to that depicted in the other embodiments. This sheetlet embodiment 100 illustrates that a single wristband form can be “extended” with the additional length of the carrier web 104 to any desired width to fit any particular printer paper processing capabilities with the less expensive paper material being substituted for the more expensive fabric material in order to save costs.

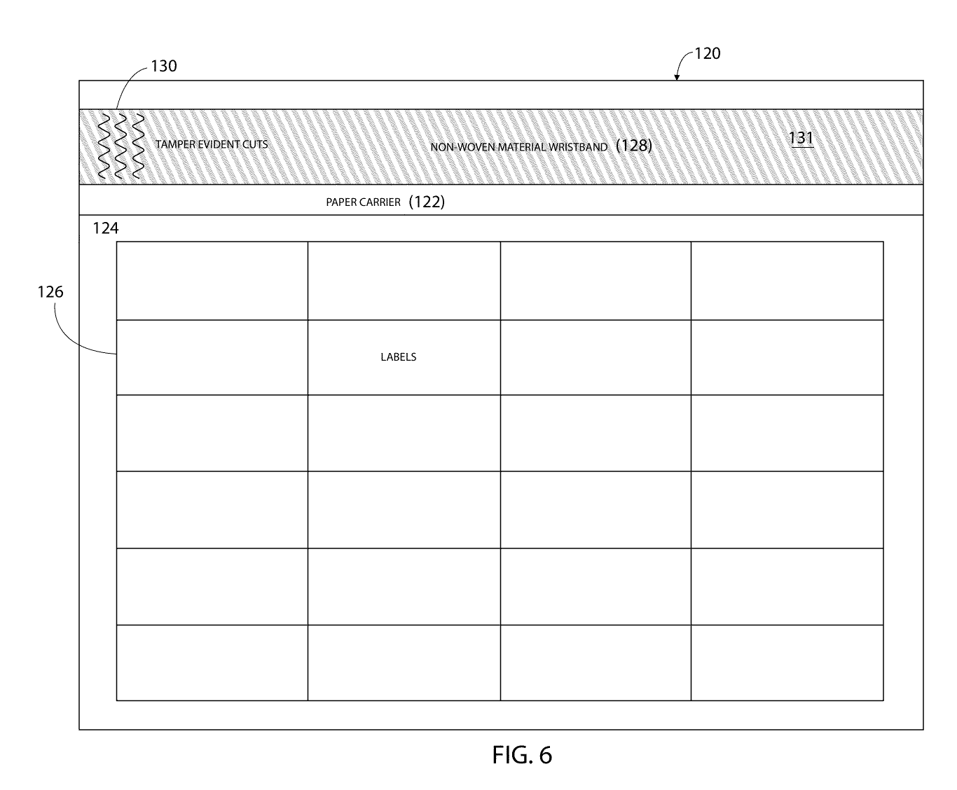

As shown in FIG. 6, a combo form 120 comprises a full page sized paper carrier 122 with a bottom portion 124 having a matrix of self adhering labels 126 and a pre-cut, non-woven fabric wristband 128 adhered thereto. A series of “tamper evident cuts” are depicted at one end 130 of the wristband 128 and separate should a wearer seek to remove the wristband and re-apply it, thereby forestalling the undetected switching of wristbands with others.

Also, as illustrated in FIG. 6 by cross-hatching, the wristband 128 may be over-printed with a layer 131 of a substance to fill in the irregular surface of the non-woven material, to thereby enhance the capability of a laser printer to create a readable image thereon. This improves the appearance of the printed material and especially its readability including not only for text but also bar codes and other machine readable information. Examples of material that would be suitable for being applied as an over-printed layer include a UV curable or water based solvent or acrylic resin or the like. While this technique may have been used before to enhance other kinds of image application, to the inventor's knowledge it has not been done to enhance a laser printer image including text and bar code information as applied to a non-woven fabric wristband.

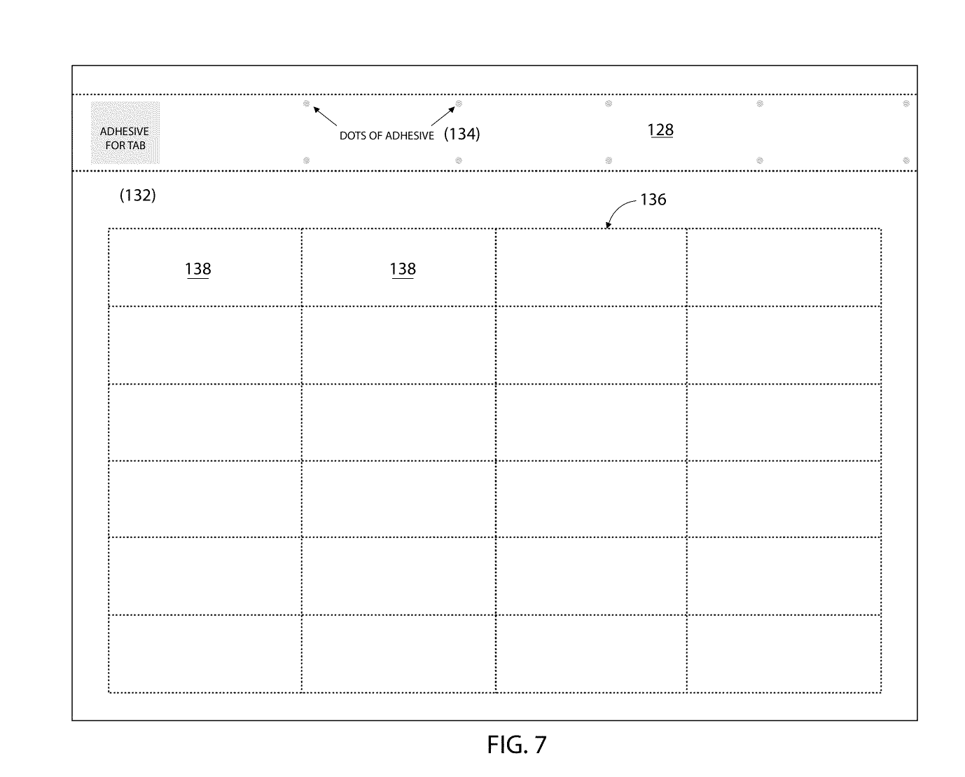

As shown in FIG. 7, a paper carrier 132 may have a plurality of dots 134 of adhesive spaced about the periphery of where the wristband 128 is applied to thereby releasably adhere the pre-cut wristband 128 to the paper carrier 132. The paper carrier 132 depicted in FIG. 7 is of a combo form, having a matrix 136 of self adhering labels 138 die cut therein. However, as would be apparent to those of skill in the art upon reading this disclosure, the same inventive arrangement may also be formed with a smaller or differently sized paper carrier 132, such as an envelope sized sheetlet.

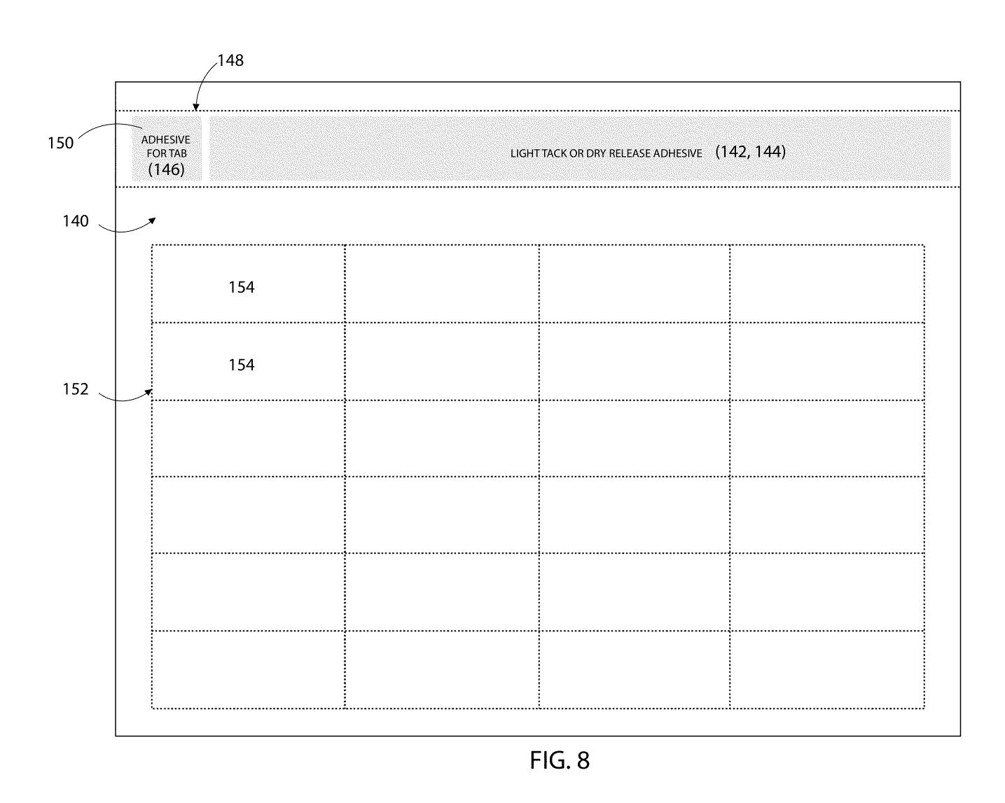

As shown in FIG. 8, a paper carrier 140 has a layer of light tack 142 or dry release adhesive 144 applied thereto for releasably affixing the pre-cut non-woven fabric wristband thereto. Also, a patch of adhesive 146 is applied to an end 148 of the wristband with a layer of silicon release 150 applied to the carrier 140 so that the wristband carries the patch of adhesive with it for securing it to a wearer's wrist. The paper carrier 140 depicted in FIG. 8 is of a combo form, having a matrix 152 of self adhering labels 154 die cut therein. However, as would be apparent to those of skill in the art upon reading this disclosure, the same inventive arrangement may also be formed with a smaller or differently sized paper carrier 140, such as an envelope sized sheetlet.

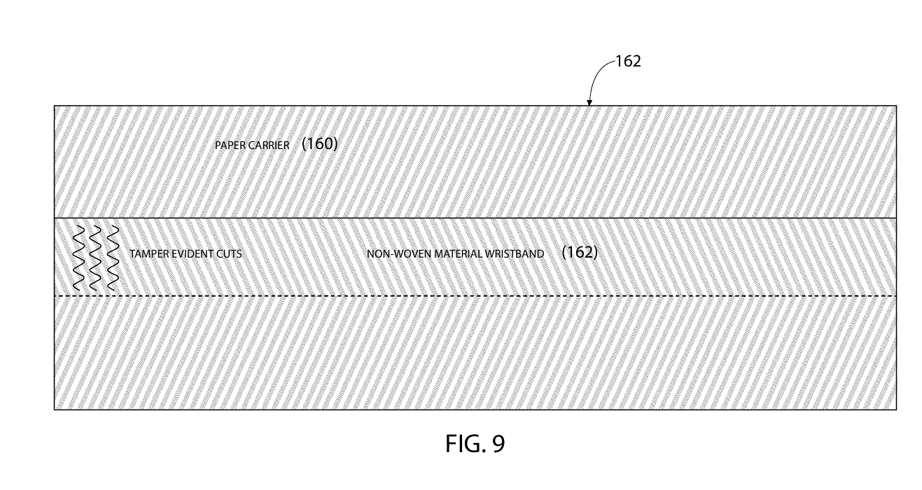

As shown in FIG. 9, a paper carrier 160 for a sheetlet sized form 162 has a pre-cut non-woven fabric wristband 162 adhered thereto. Either of the schemes for releasably adhering the wristband 162 to the carrier 160 as depicted and described herein may be implemented to make this business form 162.

The present invention has been illustrated through the drawings and detailed description of the preferred embodiments contained herein. Various changes could be made as would be apparent to those of skill in the art without departing from the teachings of the invention which should be limited only by the scope of the claims and their equivalents. For example, wristbands of different length could be fashioned in the same page sized form, such as for a Mother-Father-Baby form as known in the art. Differently sized carriers could be used as desired to fit the particular application. Other means for releasably securing the pre-cut non-woven fabric wristband to the carrier may be implemented, or even a mechanical fastener. The wristband and label portions of a page form could be oriented differently, such as by positioning the labels above the wristband. Other such changes as could be gleaned from the prior art.

What is claimed is:

1. A printer processible wristband form comprising an upper non-woven fabric web adhered to a bottom carrier web, and a die cut in said non-woven fabric web forming a wristband separable from said form.

2. The wristband form of claim 1 wherein said die cut is interrupted by a plurality of spaced apart ties.

3. The wristband form of claim 2 further comprising a layer of patterned adhesive adhering the non-woven fabric web to the carrier web.

4. The wristband form of claim 3 further comprising an overprint layer applied to said non-woven fabric web to thereby enhance the readability of the image formed thereon by a printer.

5. The wristband form of claim 3 wherein said form approximates the size of an envelope having a width of between about 4 inches to about 6 inches.

6. The wristband form of claim 3 wherein said form comprises a page, said page comprising one of a Standard Paper Size.

7. The wristband form of claim 1 wherein said non-woven fabric web and said carrier web are substantially coextensive.

8. The wristband form of claim 1 wherein said non-woven fabric web is smaller than said carrier web.

9. The wristband form of claim 8 further comprising a third web, said third comprising paper and a plurality of self-adhering labels die cut therein.

10. The wristband form of claim 1 wherein a plurality of wristbands are formed by die cuts in said non-woven fabric web, each of said wristbands being individually separable from therefrom.

11. The wristband form of claim 1 wherein said wristband form is adapted for processing through a printer utilizing elevated temperatures.

12. A printer processible, page sized, wristband form comprising a first, upper web of non-woven fabric, a lower web of paper carrier, and a layer of pattern adhesive adhering them together, a die cut in said non-woven fabric web defining a substantially rectangularly shaped strap with at least one end of said strap having a layer of adhesive, said die cut being interrupted along its length to form a series of ties to hold the strap in place on the form until separated therefrom for use, said strap being of sufficient length to wrap around a typical adult person's wrist to thereby comprise a wristband.

13. The wristband form of claim 12 wherein said upper web and said lower web are substantially coextensive.

14. The wristband form of claim 12 wherein said upper web is sized to cover less than all of the lower web and positioned adjacent an upper edge of the form and further comprising a second upper web substantially adjacent said first upper web and sized to cover the balance of the lower web.

15. The wristband form of claim 14 wherein said second upper web is made of paper and having a plurality of die cuts forming a plurality of self-adhering labels therein.

16. The wristband form of claim 12 wherein said strap is formed solely in the upper web.

17. The wristband form of claim 12 further comprising a series of die cuts in said strap end having a layer of adhesive, said die cuts forming a tamper evident indicator.

18. The wristband form of claim 12 wherein a plurality of straps are formed by a plurality of die cuts in said upper web, with said plurality of straps being positioned adjacent to each other along their longer edges.

19. The wristband form of claim 12 wherein said wristband form is adapted for processing through a printer utilizing elevated temperatures.

20. A printer processible wristband form comprising a wristband loosely adhered to a carrier web, said wristband comprising a strap of non-woven fabric adapted to receive a printed image at elevated temperatures.

21. The wristband form of claim 20 wherein said wristband is adhered to said carrier web with adhesive.

22. The wristband form of claim 21 wherein said adhesive comprises a layer of patterned adhesive.

23. The wristband form of claim 21 wherein said adhesive comprises a plurality of adhesive dots spaced about between said wristband and the carrier web.

24. The wristband form of claim 21 wherein said adhesive comprises a layer of dry release adhesive.

25. The wristband form of claim 20 further comprising a layer of adhesive applied to an end of said wristband for adhering the wristband to a wearer's wrist.

26. The wristband form of claim 20 wherein said wristband strap extends the full length of said carrier web.

27. The wristband form of claim 20 wherein said wristband is adhered atop the carrier web and the carrier is of substantially a uniform thickness throughout so that the thickness of the form is greater where the wristband is positioned.

28. The wristband form of claim 20 wherein said carrier web is page sized.

29. The wristband form of claim 28 wherein said page approximates the size of an envelope having a width of between about 4 inches to about 6 inches.

30. The wristband form of claim 28 wherein said page approximates one of a Standard Paper Size.
